(19) United States
(12) Patent Application Publication
(10) Pub. No.: US 2006/0080130 A1
(43) Pub. Date: Apr. 13, 2006

(54) Method that uses enterprise application integration to provide real-time proactive post-sales and pre-sales service over SIP/SIMPLE/XMPP networks

(76) Inventor: Samit Choksi, Hillsborough, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 11/245,792

(22) Filed: Oct. 7, 2005

Related U.S. Application Data
(60) Provisional application No. 60/617,506, filed on Oct. 8, 2004.
(60) Provisional application No. 60/678,481, filed on May 5, 2005.

(51) Int. Cl. G06Q 99/00; G06F 15/16

(52) U.S. Cl. 705/1; 709/206

(57) ABSTRACT

A system and method provides customer support to a user. In one embodiment, it includes providing the user access to a knowledge database for the user to query the knowledge database regarding a support issue. It also provides, in response to the user querying the knowledge database, an interface to the user for the user to enter a service request. Further, it establishes, in response to the user entering the service request, an instant messaging session between the user and a customer support representative.

### CROSS REFERENCE TO RELATED APPLICATIONS

This application claims a benefit of and priority under 35 U.S.C. § 119(e) to U.S. Provisional Patent Application Ser. No. 60/617,506, “A Method that Enables Customer Support over Instant Messaging Technology Integrated with Enterprise Applications,” filed Oct. 8, 2004, and U.S. Provisional Patent Application Ser. No. 60/678,481, “Method That Uses Enterprise Application Integration To Provide Real-Time Proactive Service Over SIP/SIMPLE/XMP Networks,” filed May 5, 2005, the contents of each of which are hereby incorporated by reference.

### BACKGROUND OF THE INVENTION

1. Field of the Invention

The present invention relates generally to conducting automated and live conversations over any SIP, SIMPLE, and XMPP based protocols. More particularly, it relates to users being able to access automated self-service features provided in enterprise applications and live chat conversation over a single Instant Messaging session.

2. Description of the Related Art

Large corporations have customer support centers (CSCs) whose purpose is to support users of the corporation's products and/or services. Typically, a corporation's customer (hereafter a “user”) calls a toll-free number, waits for a customer support representative 1 (CSR) to answer their call and then the CSR attempts to solve the user's problem. The CSC maintains a database of information about a SR (service requests, the set of questions asked, resolution attempts, etc.) so that CSRs answering subsequent calls can have the support history for reference. As a standard practice, customer support organizations maintain records of inbound support calls, by creating an SR. The conversation and details of a customer issue, if solved can be reused to help future customers that report the same or similar issues.

Currently customers communicate with CSCs by telephone. For example, imagine that Mary's new ABC 2000 computer is not working properly. She calls ABC's toll free number, 1-800-ABCCORP. The computer that answers the phone (many CSCs use Interactive Voice Recognition systems) likely asks her a series of questions, such as “Do you have the ABC 1000 or 2000?” or “Do you have a network card installed?” “What brand of network card? Press 1 if it's an XYZ card . . . ” etc. The automation of this information gathering saves the ABC corporation time spent by a live agent, but is frustrating for Mary. If Mary has answered the above questions, she has a potentially lengthy wait before she can talk to a human, often in excess of ten to twenty minutes. Finally, if her question is not answered to her satisfaction, Mary calls ABC's CSC again. There are some systems that allow users to go directly to the CSC's queue, at which point Mary can activate her existing service request. And, some systems prefer Mary to go through the automated menu before being connected to a CSR. In both cases, Mary's customer profile has a record of her problem history, but she still faces a lengthy wait for a human representative.

More recently, methods have been devised to allow users to obtain help via a text-based chat technology called web chat. Web chat has been used in a variety of ways, which provide different functionality. First, some web sites provide an instant-messaging-like web browser window through which users can ask questions. If a user asks a question, an automated reply is generated through an Instant Messaging robot (BOT) that may provide results from a knowledge base. Alternatively, a web chat link can connect a user directly to a human CSR at the CSC. Since the replies are not automated, the user is placed in a queue before a CSR can attend to them. The user sessions can be placed in the same queue as other inbound calls.

These web chat based tools have been used for sales and support. However, these methods are not integrated with the CSC's CRM applications, so users are forced to reenter information, wasting both the user's time and the CSR's time. Current web chat system provides their own hosted ticketing system, which the CSC uses to record their SRs. Additionally; web chat does not encompass the presence technology that is a key advantage of public Instant Messaging applications. Furthermore, web chat is simply a direct conversation between two users as opposed to Instant Messaging, which allows a single user to chat with other members in their group. Therefore, in a customer support scenario if the connection is lost during a web chat session, the user has to login again and wait in queue until they can reach a CSR.

Additionally, web chat providers have started providing the CSC's with a flat file of the users chat session, to use for analytics; the same way phone support conversations are recorded. To a CSC this data is a valuable asset in improving customer support, product strategy, marketing, and increasing future sales. Data mining tools have been used on top of this existing set of data to extract useful information. Having a knowledgebase of past cases and solutions to them also forms the basis of building Knowledge Management systems, Case-Based Reasoning systems, or Email Management systems. These systems follow the heuristics approach, where the system tries matching similar problems and their solutions to new problems, and/or reasoning about solutions to new problems based on an understanding of previous solution methods and techniques.

Such conventional systems, however, continue to have drawbacks. For example, what happens if there is no perfect match to a new problem, from the domain knowledge of existing problems? New problems have to be entered before the system can use it to provide the next user with a solution. Even still, the solutions entered here are not in real-time, since they have to be formally written and sent through an approval process before they can be used again. The existing computer systems are also built to handle burst issues, since this is how customer support issues occur. Current methods have attempted to be proactive, by making announcements of the issues through websites, or phone recordings, or emails. Nevertheless, the support processes still remain disparate and reactive with problem solutions not being available in real-time.

### SUMMARY OF THE INVENTION

In accordance with one embodiment, a system may be configured in which there may be three principals involved: a user (a person who has a problem with some good or service), a customer support center (CSC, a service of the corporation that is responsible for said problematic good or service) and the IM support server (which may include a computer system that serves as an intermediary between a CSC and its users to automate some of the current manual processes). Note that the user is a customer of the CSC, but the CSC is also a customer of the IM support server (which supports the transaction). A “customer support profile” (meaning, information that the CSC keeps about a particular user) may be used rather than “user support profile”.

The invention covers a system and a process (or “IM support server”), which facilitates access by ordinary users to enterprise-level applications via public Instant Messaging (IM) networks. These enterprise-level application tools are used by customer support centers to monitor, track, and respond to user queries. The system and the process differ from existing customer support technologies in many ways. Firstly, through Enterprise Application Integration (EAI) and using Instant Messaging technology it allows a user to interactively submit a support issue without having a customer support representative (CSR) involved. Second, users can “chat” online with a live CSR who is now aware of the details of the customer's issue. This is possible, because the disclosed technology integrates directly with the enterprise applications that the CSRs use to track and monitor their customer's support issues. Additionally, by using an IM client it allows the present invention to make use of the “presence technology,” a unique value provided by IM networks.

The IM clients provide a notion of “online”/“offline” status that allows a user and a CSR to efficiently agree on a time to chat. Furthermore, the present invention shortens average call times and reduces the number of CSRs that are desired to service an existing customer base, which allows substantial savings for the enterprise. An optional component of the technology that helps to reduce call times is described below as the “Message Index,” which is a self-learning environment that is capable of handling customer calls through its pool of Instant Messaging sessions. The Message Index looks at each individual user message and CSR response as valuable pieces of knowledge, and uses that to automate user IM conversations to a point where the conversation absolutely requires human intervention.

One embodiment of the present invention includes an “IM support server.” The IM support server delivers a combination of automated and live support technology that enables a user-friendly and more satisfying support process for a user. The IM support server also reduces costs for the CSC. It delivers multiple levels of support by providing the user with a self-service option, unless the complexity of the problem forces them to move to a live channel. The multi-layer support application allows a user to query a knowledge base, create a service request, and open a live chat session, through a simple and widely used interface, called the Instant Messenger. The Instant Messenger is an application bundled with a proprietary set of tools and communication protocol running on public networks that have been developed by providers such as Yahoo!, MSN, and AOL. By linking the online networks and the phone networks, the IM support server can provide the user an integrated support channel over a single interface.

An advantage of the IM support server is that it utilizes the power of enterprise-level applications and presents these applications in a user-friendly interface for both average users and expert users. To initialize the support process, the user adds a CSC's IM buddy on their instant-messaging client. A CSC would either have a domain name specific ID, such as; support@abccorp.com or a generic ID such as; abc_support@yahoo.com. The transition between the three lines of support is seamless: if the user does not find a solution in the CSC's knowledge base, they can then move to the next line of support, whereby they can log a service request using the service module. The knowledge base and the service module are the two self-service channels. After submitting a service request the user can choose a resolution type, to chat with a CSR using the IM tool, or they can resolve their problem through email or phone.

The IM support server can be configured in a different order to provide support. For a system or agent to provide a user with a solution, the users problem is first understood. The previous configuration allowed the user to first search a knowledge base, and if they do not find a solution then they would be able to provide a detailed description of their problem by submitting a pre-configured service request. An alternative method the IM support server offers is to reverse the previous order and ask the user to complete the service request as their first line of support. The IM support server will then use the answers provided in the service request to do a search for solutions in the knowledge base. If the user is not satisfied with the solutions provided, they can then choose to submit the SR they created.

In addition to providing customer satisfaction, the IM support server is beneficial to the enterprise by reducing the cost of an inbound call. By automating the CSR responses for common recurring issues, the automated response layer will act as the IM support server's level 1 support. The Message Index is a component, which can be built on top of the IM Chat module, because the Message Index uses the real-time chat conversations to build its memory of messages. This compares to the inductive process that artificial neural networks rely on to build patterns and generalize data so that the best possible solution can be given. During a chat conversation, a users question or IM message typically follows a CSR's response. The human CSR uses their own heuristics to provide the correct response from their pool of knowledge. If a machine is programmed with the same heuristics, it can replace the human and pick the correct answer to send back to the user.

With approximately 14 billion instant messages being sent a day over various networks, the conversations of users can cover a broad that scope. With such a large quantity of messages being exchanged we can safely assume that for a message sent by a user A there is either one or multiple same or similar messages sent by several other users, which would result in similar responses. However, the natures of messages are broad users can be chatting about personal information, solving problems, or making general statements in a single IM session. The Message Index does not concern itself with these general messages, because monitoring these would incur tremendous compute power and not be legal due to user privacy issues. The Message Index instead focuses on customer service issues that are targeted towards a single CSC, which would drastically reduce the machine intelligence, since we know that messages coming from users would almost always be related to products or services, supported by the CSC.

To further help the reasoning of how to provide intelligent IM responses, we can use the relation between support issues at a CSC and Pareto's Principle, where 80% of the customer support calls are related to the same or similar issues, and so should require less time to resolve. As a result in current support centers, CSR's are provided with daily statuses of what the top 10 problems are, allowing them to focus less time on the trivial many, and more on solving the vital few issues for which no solution has been created.

To explain the Message Index functionality, the users questions and statements are classified as IM messages that are in the form of “questions” and the CSR's response messages as “answers.” During any session, the Message Index logs the complete chat transcript and indexes it using an algorithm, which groups user questions by products or services listed in the metadata documents used for the SR templates. The XML metadata is useful because it provides the Message Index with updated products and services to create new index pools. A logical reason to index by the products or services provided by the CSC is, because the IM support server already knows the issue that the user is requesting support for if they complete the SR template, so these can also be used as grouping categories for the index pools.

An alternative method to do this is also by asking the user an initial chat question; regarding the product or service they are having problems with. To narrow the search and pinpoint the user problem, from the time the users session begins the Message Index starts storing in memory the keywords used by the user that match keywords in the XML document. If it reaches a threshold value, it can identify which pool of questioning the users issue could be linked to.

The Message Index uses a top down approach where a users question is first linked to an existing question in an index pool; thereafter the answer with highest rank is picked as a response to the question. With every question, the user is expecting a response. The Message Index attempts to provide the best possible response based on the users question. For a question that is logged, the corresponding responses provided by the live CSR's are also indexed and assigned a rank, based on the frequency of use. In certain cases, a question may have a single answer, but in a case where there is a many to many match between questions and answers the best answer would be given the highest rank. For faster search techniques, the algorithm can also begin the searches with the top 10 solutions that were provided for the day, which would equate to the issues that arise in bursts.

The Message Index cannot replace the live CSR completely, but rather solve the recurring instance of the same issues in an automated, intelligent, and user-friendly manner. The Message Index can now manage the trivial many issues using indexed live user-CSR chat conversations. The CSR will only solve new issues, which will help build the Message Index's log through real-time updates of those conversations. Another advantage of the present invention includes convenient Instant Messaging. For example, for millions of Internet users Instant Messaging is more convenient than waiting on hold on the phone. An Internet user can be browsing the World Wide Web and have an IM conversation with a live CSR. Enabling these users to communicate with the CSC in this manner results in improved user satisfaction.

Yet another advantage is elimination of long hold times. For example, Instant Messaging is well suited to the typical way that users interact with CSCs. In particular, in the current phone support process, users are typically faced with a lengthy wait for the next available CSR, and have little choice but to wait, listening to irritating hold music. With Instant Messaging, however, the user can submit a request and then the CSC alerts the user (by appearing in the user's instant messaging client as “online”) if the request is next in queue and the CSR is available to chat. That is, if connecting to a CSC via Instant Messaging, the user can do something else and wait for a CSR, since the user knows that he or she can respond to the available CSR at a time of his or her choosing. Instant Messaging is a “presence tool”: it facilitates text-based messaging and keeps track of which user or CSR is online.

Still another advantage is the speed offered by reading over listening. For example, Instant Messaging is a textual interface to a CSC and, as such, can potentially be much more efficient than an audible (spoken) interface. For example, if a CSC wants the user to select one or more of ten options then a human voice at the CSC says to the user something like “press one if your question is about printers, press two if . . . ” With a textual interface such as Instant Messaging, the user reads the list of options, rather than listens to them. Moreover, because we can read much faster than we can listen, the resulting conversation between a user and the CSC is faster and less aggravating for the user. Furthermore, listening to the speaker is limited by the rate at which the speaker speaks; for reading, on the other hand, the user can selectively skim some sentences and more closely read others. In particular, a returning or expert user can visually focus on the parts of a menu that he or she is interested in without bothering to read the other options. A single textual interface can satisfy both new users (who want a comprehensive and detailed description of an option) and returning or expert users (who don't want to sit through long-winded descriptions of options).

Another advantage is a reduction in the number of calls. For example, an Instant Messaging interface to a CSC can seamlessly provide both the ability to chat with a CSR and the ability to search a company's knowledge base and FAQ's. The IM support server's process is structured to reduce the number of support calls and related costs. The process forces a user to first search the company's knowledge base over an Instant Messaging knowledge search before talking to a CSR. This process filters the customer issues that can be answered through self-service before it reaches a CSR. This is advantageous for both parties: the user can quickly and easily find an answer to their question, and the CSC can answer a user's question without using a live CSR, who is expensive.

The first message can also be changed by the CSC to give the user a choice, whether they wish to search the knowledge base or directly chat with a CSR.
Welcome to ABC Corporation's Customer Support Center.
Type “1” to search our knowledge base.
Type “2” to chat with a customer support representative.

Allowing the CSC to change the support process is key flexibility of the IM support server, which CSC desires if they wish to channel their customer issues directly to the CSR. The IM support server is still beneficial to the CSC, because it requires the user to log his or her own SR data, whereby reducing the data entry time required by the CSR.

Continuing with advantages, another is that Instant Messaging can reduce average call times. For example, an interaction between a user and a CSC that is based on Instant Messaging can move the responsibility for extracting certain information about the user's question from a human CSR (who costs money) to a computer (that is much cheaper). For example, if Sam calls the ABC Corporation about a problem, the human being that Sam finally talks to has to ask Sam a series of questions in order to understand and resolve Sam's problem. For example, the CSR likely wants to know which of ABC's products is the subject of the call, and how that product is configured.

With an interaction that is based on Instant Messaging, however, a computer can ask the user a series of text based questions that the user needs is to answer before being allowed to “chat” with a CSR. A fraction of a call to a CSC is wasted by this kind of simple, albeit necessary, information gathering. By automating this process, the corporation can save money and improve end user satisfaction. For the company that owns the CSC, this is an important advantage of Instant Messaging based call center interactions over traditional phone-based interactions, where such automated entry is used, but has proved unsatisfactory in the eyes of the end users.

A further advantage is that CSRs can handle multiple simultaneous sessions. For example, with phone-based CSCs, a single CSR talks to a person at a time. With Instant Messaging based CSCs, on the other hand, a single CSR can easily handle multiple user conversations simultaneously. With Instant Messaging, a delay of around 10-20 seconds between text messages is considered normal. If talking on the phone, such a delay is intolerable. Other aspects of the invention include methods corresponding to the devices and systems described above.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

The invention has other advantages and features which will be more readily apparent from the following detailed description of the invention and the appended claims, when taken in conjunction with the accompanying drawings, in which:

FIGS. (FIG.) 1A-1E illustrates one embodiment of an architecture diagram that encompasses both the present invention and the environment in which it is designed to operate.

FIGS. 2 and 3 illustrate one embodiment of exploded views of two components of the present invention.

FIGS. 4A-4B illustrate one embodiment of which components come into play if a user initially connects to an enterprise system and process in accordance with the present invention.

FIGS. 5A-5C illustrate one embodiment of components that are used if a user is interacting with the CSC's knowledge base via the system and IM Knowledge module.

FIGS. 6A-6F illustrate one embodiment of which components are used if a user is interacting with IM Service.

FIGS. 7-7A illustrate one embodiment of a final step in the support process, showing which components are used if a user is interacting with a live CSR through the IM Chat module.

FIGS. 8-8B illustrate one embodiment of a placement of the Message Index component, which structures and indexes chat messages to be used for future automated chatting.

### DETAILED DESCRIPTION OF THE PREFERRED EMBODIMENTS

The Figures (“FIG.”) and the following description relate to preferred embodiments of the present invention by way of illustration only. It should be noted that from the following discussion, alternative embodiments of the structures and methods disclosed herein will be readily recognized as viable alternatives that may be employed without departing from the principles of the claimed invention.

Reference will now be made in detail to several embodiments of the present invention(s), examples of which are illustrated in the accompanying figures. It is noted that wherever practicable similar or like reference numbers may be used in the figures and may indicate similar or like functionality. The figures depict embodiments of the present invention for purposes of illustration only. One skilled in the art will readily recognize from the following description that alternative embodiments of the structures and methods illustrated herein may be employed without departing from the principles of the invention described herein.

An example embodiment of the present invention is shown in FIG. 1; in this example, a user (1) who uses an Instant Messaging client to communicate via the Internet (2) with a corporation's customer support center (CSC)(4) via the IM support server (3).

The IM support server 3 contains a number of subcomponents. The Response module (3.1) interacts with the various Instant Messaging systems on the Internet. This module insulates the rest of the IM support server from the intricacies of different Instant Messaging systems. The Response system is a J2EE component that can talk to the API's provided by various IM providers. A large pool of these components can be created for scalability and performance. The response would be a stateless server running in a standard J2EE container. It would use either an object relational or standard JDBC technology to communicate with the RDMS. The Response can be treated more or less like a BOT, the core logic of which is stored in the Broker (3.3) Several BOT's will be created for an IM network. To provide appropriate load balancing, duplicate BOT's may be created if the number of user sessions increase.

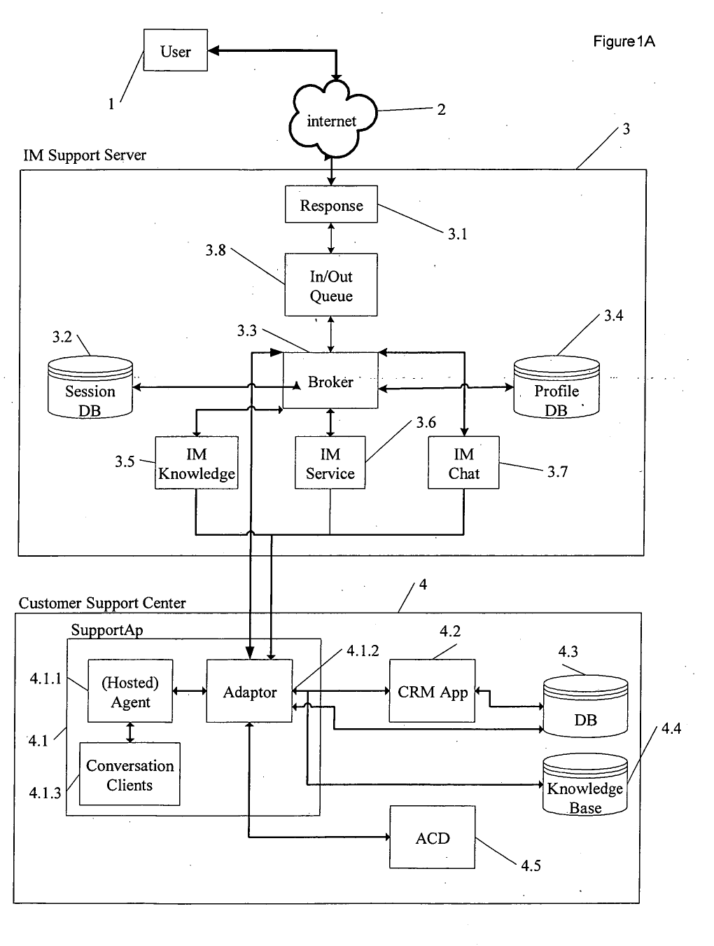

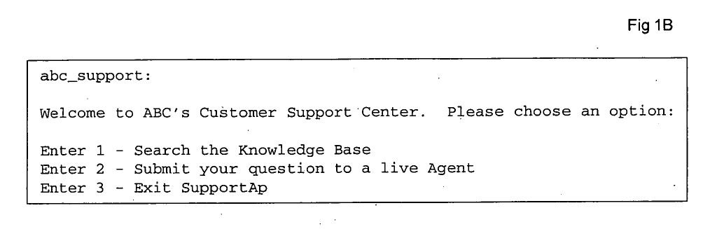

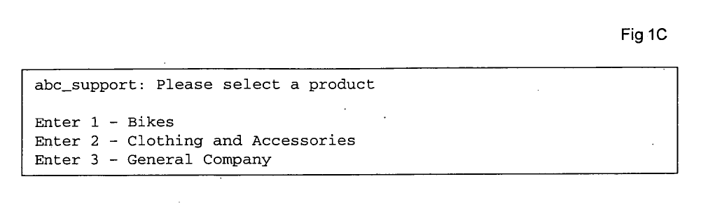

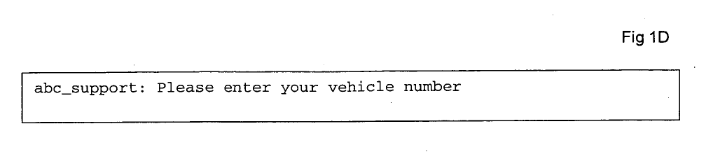

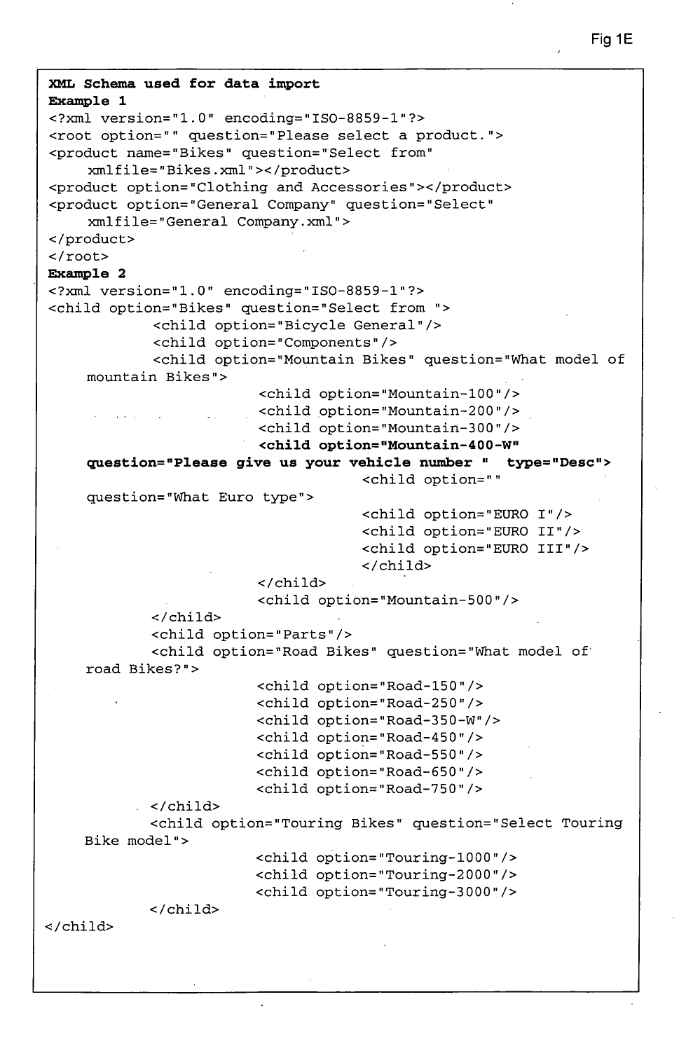

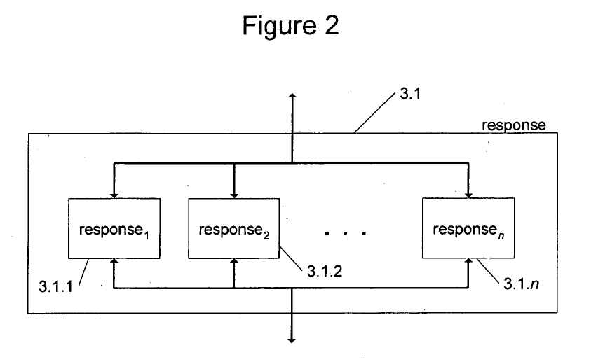

FIG. 2 shows how the Response module is made up of a collection of similar sub-modules (3.1.1-n), which have the same functionality, but are responsible for messages to and from a particular type of Instant Messaging system. For example, in a particular instantiation of this embodiment, module (3.1.1) could handle messages to and from Yahoo! Messenger, module (3.1.2) could handle AOL chat, and module (3.1.3) could handle MSN Messenger. These sub-modules hide the details of a particular instant messaging system from the rest of the system. Furthermore, the IM support server will be handling millions of IM sessions from users and CSR's.

To provide the same level of service to users the server balances session loads between multiple instances of the Response module (3.1). The Response module will create multiple instances of the same Response client based on a maximum load parameter. So at any given point in time (3.1.1) may have user messages channeled through several Response modules, based of the same IM network protocol.

The Broker module (3.3) is configured to include core business logic that decides how to interpret a message from a user and decides on the appropriate response to send back to a user. An incoming message from a user is forwarded by the Broker module to one or more of the following three modules: the IM knowledge module (3.5), the IM Service module (3.6) or the IM Chat module (3.7). Incoming messages are parsed through a Queuing interface (3.8) which contains an “In Queue” and an “Out Queue.” These queues are maintained to manage messaging quality, so that messages from a user are not lost within the Broker. In response to a message being sent by the user, the Broker will ensure that if a response is desired by the user, it will be delivered into the Out Queue. In addition, if the Broker or the user does not receive their messages, they can be resent multiple times through the queues.

A new user session is started if a message from a user is received by the Response module (3.1) and forwarded to the Broker (3.3). The Broker sends a message back to the user, via the Response module. The contents and the appearance of the message can vary, as shown by way of example in FIG. 1B.

In this example, a user replies with “1” to begin their search. The Broker module (3.3) has built-in error handlers to better understand how users may respond. For instance in response to the menu in FIG. 1B being shown, the user may enter in text form “One” instead of entering the number “1.” In this case, the IM support server (3) sends a confirmation message, asking the user whether they meant to choose option “1.” After any menu option is shown the IM support server (3) uses this logic to better replicate a human responding rather than a computer-based system.

In response to the correct option being entered, the IM support server (3) responds with a message that asks the user to enter their search in simple English. The user then replies with a phrase; for example, they could enter “bank account”. The IM support server (3) transmits this message through the Agent (4.1.1) directly to the CSC's knowledge base (4.4) where the query is processed. The CSC then sends any results to the IM support server (3), which in turn provides a set of links to the user as a search result. As an example, three links are provided to the user in a single message. If there are more than three results, the user is given an option of viewing the next set of links (for example, by typing ‘/more’). The user can then click on any of the links to open the results in a web browser. Based on the CSC's preference and if it is a text message, the query results can also be sent back in the IM session window itself. If the user sent the search phrase “bank account”, and no information for this phrase is found then the user is shown the same menu, with an option to search again.

At any point, the user can view the main menu (for example, by replying with ‘/menu’) where they can have the option to search, interact with a live Agent, or exit the process.

The second step in the process is the IM Service module (3.6), which obtains new SRs from the Agent (4.1.1). The IM Service module and the Agent can use various different protocols that result in the Agent sending the IM Service module a new SR and the IM Service module sending information about the user's problem to the Agent. For instance, some CSCs may be judicious about creating new SRs so the protocol used desires the IM Service module to first send the information about the problem to the Agent. If the information is vetted then the CRM application sends the IM Service module the new SR (via the Adaptor (4.1.2) and the Agent (4.1.1)). Alternatively, the CSCs may prefer a streamlined protocol that reduces network traffic: the IM Service module initiates the protocol by sending the user's information to the Agent and the Agent responds with the new SR number.

The IM Service module acts as a user front end for the CSC's CRM application (4.2), by logging a user's cases in the CSC. The IM Service module can be viewed as an IM based IVR system with enhanced functionality for both the user and the CSC. Conventionally, CSRs have manually entered data into a new SR; however, the IM Service module (3.6) allows a user to enter their own data. The data entry process compliments for level 1 support in a support organization. By reducing the amount of time that a CSR spends on a SR, the company can now align their support resources more effectively and benefit from a cost-effective support model.

The user is moved onto the IM Service module (3.6) after they have interacted with the IM Knowledge module (3.5). If the user cannot find answers on his or her own, the IM Service module (3.6) allows them to submit their problem to a live CSR for resolution. The IM Service module (3.6) is a component of the IM support server module (4.1) at the CSC, which allows the CSC to load different SR templates into their IM support server profile. The questions are unique for an enterprise because they are based on the information their support organization uses to solve a problem. The user simply creates an SR through their Instant Messaging client, which the IM support server then interfaces into the CSC's CRM application.

For a CSC to integrate with the IM support server (3), they expose the metadata and options used to complete a service request in their application. The IM support server understands the CSC's SR structure through a decision tree method. The decision tree is replicated into an XML schema (an example is shown below), which is understood by the IM support server to build an interactive SR template for the user. Using the XML schema the Broker will store a local repository of the customers SR template on the IM support server. An alternative is to store metadata and the options in a database. This is not preferred, since it would cause data redundancy, and put heavy loads on the system if large numbers of users are trying to build simultaneous SRs. Therefore, the ideal solution is to user a combination of in memory storage and database storage for persistence.

The implementation of the decision tree XML schema will be done at two levels. There will be a customer specific master XML file which will hold information about the base root elements or base templates and will also contain Info about the subordinated XML file to be looked for (See example 1 and 2 in FIG. 1E). An example of a base root can be a “Product Name”, and the “Product feature” would be the options stored in the subordinate XML file.

FIG. 1C illustrates one embodiment of a user interface configuration in which the first question asked to the user after authentication will be the root element or base product under which all services or issues would be related to. Depending on the option answered by the user, the related document mentioned in the attribute XML file will be referred (xmlfile=“Bikes.xml”) for further questions.

Here descriptive and non-descriptive questions will also be taken care of. (FIG. 1E Example 2). The questions that have options provided are non-descriptive questions. Non-descriptive questions are those questions where the user will be given options to select from, for example, as shown in the user interface views of FIG. 1C. Descriptive questions are easily distinguished since there will be an attribute (type) specified in the xml tag <child option=“Mountain-400-W” question=“Please give us your vehicle number” type=“Desc”>. Descriptive questions are those where the user is asked for some specific information that is entered in free form text, for example, the vehicle number or the user problem description, for example, as shown in FIG. 1D.

FIG. 1E illustrates one embodiment of XML Schema used for data import. In response to data having been imported into the CSC's profile, the SR templates can be manually updated through the Agent module, which is deployed for a CSC. If the user submits an SR, they can choose how to receive a resolution. Examples of how to receive a resolution include resolution by mail, by chat, or by phone. For resolution by email the CSR researches the problem and sends the user a fix or an update to the SR by email. For resolution by chat the user accesses the IM Chat functionality of the IM support server (3). The SR is queued and routed to an appropriate resolving group via the IM support server (3). The user can now chat with the next available CSR. This process is further described as part of the IM Chat module (3.7).

For resolution by phone the user is put into a queue to chat with a CSR. The user still calls the CSC, but the user who creates the SR online could typically have a shorter resolution time, since the CSR may already have a solution ready if the user calls (Since this is a change in existing business practices, the CSC decides on this prioritization, but the IM support server (3) allows them to queue the SR's in the regular queue). This encourages the user to log their problem online before choosing live support, hence reducing the number of CSRs and reducing the amount of time that users spend on the phone.

The IM Service module (3.6) allows users to submit complex SRs through a simple and intuitive process. The creation and management of SRs, if they have been submitted, is done by the CSC. Resolution status is also changed by the CSC's CRM application (4.2), which the IM support server (3) then pushes through to the user.

The IM Service module (3.6) manages the queuing of SRs. Before an SR can be migrated to the CSC's CRM application (4.2) or ACD (4.5), the IM support server queues the request in its own instance before de-queuing on the CSC's queue. This process could change depending on the CSC's security preferences for handling user data. The IM support server (3) may have direct access to the queue, through which no user data would be stored on the IM support server side, but instead migrated directly to the CSC's queue. Alternatively, the queue management can also be done through the Agent module, since interactions between the IM support server instance and the CSC's instance go through here. Since this interaction can be done over a secure HTTPS channel, user SRs can be stored on a local queue created by the Agent module. The queuing rules can be set through admin screens provided by the IM support server.

Moreover, storing an SR in the IM support server queue is vital for three reasons. First, the IM support server monitors transactions that are utilizing the SR and Chat functionality. In response to an SR entering the queue, a transaction is initiated. The transaction is complete if the SR has been removed from the queue. Second, for users who do not have an existing service management solution implemented, the IM support server instance queues and store SRs for them. The queue can be used actively, with the CSC setting routing rules on the IM support server instance and creating resolution groups.

Alternatively, the queue could be used simply to store user SRs, before it is interfaced with an ACD on the CSC instance, since the CSC may be managing separate queues on their end for phone, email, and chat calls. Finally, queuing SRs in the IM support server is important because if a user has asked to chat then the SR acts as a key that establishes a chat session through the IM Chat module (3.7). This session remains open in the queue until the SR has been resolved by the CSC.

The IM Service module (3.6) can be accessed if the user has submitted a search query through the IM Knowledge module (3.5). In comparison to current customer support, IM Service acts as the level 1 support interaction between the user and the CSC. Current call centers classify level 1 support as capturing the users issue, thereafter it can be routed to a subject matter expert. In response to the user having been authenticated by the IM support server (3), the user is provided with the example options below (known as the IM Service Menu):
Create a new Service Request
Update an existing open Service Request
View closed Service Requests
Exit SupportAp

In this example, the user selects the “Create a new Service Request” option to raise a new SR. Thereafter the user is asked a series of questions, along with the possible answers for that question. These questions are set up by the CSC in their CRM instance and then replicated by the IM support server for the user.

The CSC can create templates that are branched by the option the user selects in their first answer. This logic is built into the Broker module (3.3). The Broker interfaces with the Adapter (4.1.2) to receive the CSC's SR templates. A CSC with a CRM application running would already have SR templates they are using to record their existing inbound support calls. Through the Agent module (4.1.1) the CSC can trigger an auto build an SR template that replicates and interfaces with the CSC's existing CRM application. The individual SR questions, and its list of options are presented to the user on their Instant Messenger session through the Broker. A question that the user is asked is followed by a list of values from which the user may choose, or the user can answer the question in free form text. For the list of values, the user answers the question by typing in the option number that corresponds with the value they wish to use. Thereafter the user is asked a series of questions based on their initial answer. At the end of a set of questions, the Broker (3.3) adds a question, where the user is asked to describe their problem in free form text. After the last question the user is shown a summary of the SR that they created, so that they can confirm their answers. The IM support server then presents the user with the following example menu:
Enter 1—Submit the Service Request
Enter 2—Start over.

After submitting the SR, the user is given both an SR number and an estimate of the delay before a CSR will attend to them. The status and time information is taken from the CSC's ACD or CRM applications, in response to the SR having been placed in the CSC's support queue.

The IM Chat module (3.7) is the final layer of the IM support server's support process. In response to the user having used the self-service channel (i.e., the IM Knowledge module (3.5) and the IM Service module (3.6)) they can then choose to chat with a live CSR. The chat session is initiated if an SR has been submitted, so that the CSR can read the problem details before they chat with the user. From the user's perspective, the interaction with the IM Chat module is similar to a regular Instant Messaging chat session that takes place between the user and the assigned CSR. The IM Chat module also packages several functions that add value over existing web chat technology, service requests can now be created in the CRM application by the user, saving the CSR's time, allowing them to focus on problem diagnosis and solution, rather than data entry.

If an SR has been submitted through the IM Service module (3.6), the user gets one or more of the following responses from the IM Chat module; resolution time, resolution status, SR in queue alert, agent available alert, view open SRs, view closed SRs, or update SR. Each is further described now in more detail.

Resolution time is reviewed first. The SR is placed in a common queue in the CSC instance. This queue can be separate for chat SRs, or common to other SRs logged through phone and email. If the user chooses resolution through chat, the application returns an estimate of the delay, in minutes, until a live CSR will be available to chat. Depending on an individual CSC's specifications, either there could be a common support queue or there could be multiple queues, depending on how the CSRs are trained. That is, a CSC may have dedicated CSRs for chatting and others for phone support. The configuration chosen will affect the average wait times for different users.

Next, resolution status is reviewed. The user can add a support organization in their Instant Messaging window as an IM buddy. Open SRs are grouped under a single IM buddy on the Instant Messaging window, until they have been closed. Additionally there can be an IM buddy for closed SRs so that the user can view their history of problems encountered. For example, for any given user there can be a maximum of two IM buddies per CSC and a minimum of one IM buddy if the user initially adds the CSC as a provider.

Referring to SR in queue alert next, if the user first logs into their Instant Messaging client, an alert shows that highlights their open SRs. It also asks them whether they wish to be placed back in the queue. This allows CSCs to be proactive in their support offerings rather than reactive in waiting for a user to request support.

With the agent available alert, if the user is in an existing Instant Messaging session, the alert appears if they have open SR that is next in the queue to be attended to by a CSR. With view open SRs the user can view their open SRs through a menu option on the Instant Messaging session. Next, with view closed SRs the user can also view the history of their closed SRs through a menu option on the instant-messaging session. The closed SRs maybe grouped under a single buddy. A user can choose this option in order to view the SRs at any time. Finally, with update SR the user can update the problem description (which is a free text field) on their open SRs through a menu option on the Instant Messaging session. The IM Chat module builds the link between the user and the CSC's CRM applications that keep track of user queries. The Chat module also builds the key link between a user and an individual CSR at the CSC.

The IM support server (3) maintains two databases: a session database (3.2) and a profile database (3.4). The session database (3.2) maintains information about the conversations or sessions that are currently active, including information that a user has offered in response to a question about their problem. Answers to an SR are stored here before they are sent to a CSC's CRM application (4.2). The user sessions can also be stored in memory in hash tables for quick access to current session status. For example, if a user wants the IM support server to repeat a question, it would be faster to make a call into memory rather than into the database. An actual session database can be used for backing up session data for extended storage. The profile database (3.4) maintains a mapping from a user's Instant Messaging identifier (typically an email address) to an identifier that the corporation's CRM database uses to identify the user. Note that this is a many-to-one mapping: a user exists once in the corporation's CRM database, but users can communicate with the corporation's CSC via different Instant Messaging clients (for example, Yahoo! Messenger and AOL Chat). The profile database can also maintain record of the information that normally resides on the CRM application's database (4.3) about a user. Caching some of this data inside the IM support server (3) helps reduce network traffic between the IM support server (3) and the CSC (4).

The CSC's computer system (4) contains various components; some (4.1) are extensions of the IM support server, the remaining components (4.2-4) are part of the CSC's existing computer system. The components (4.1) are responsible for interfacing between the CSC side components (4.2-4) and the IM support server components (3). The Adaptor (4.1.2) is the single entry point through the CSC's firewall to the IM support server components (3). The Adaptor ensures that user information in the CRM application's database (4.3) and in the IM support servers cache (3.4) is synchronized, through a Service Oriented Architecture that uses Web Services technology to transfer data between the IM support server and the CSC. That is, if information about a user's profile is changed in the CRM application's database (4.3), the Adaptor (4.1.2) sends a message to the profile database (3.4) telling it to update its records, and vice versa. In addition, the Adaptor (4.1.2) decrypts messages from the IM knowledge module (3.5), IM Service module (3.6) and IM Chat module (3.7); and encrypts messages that it sends back to the Broker module (3.3), to interface with other components of the IM support server. The Adaptor (4.1.2) also authenticates Instant Messaging users against the CRM application. That is, the Adaptor (4.1.2) knows that “sam@aol.com” is actually customer #012345 and it authenticates (say, by password) that the Instant Messaging user really is who he or she claims to be.

Finally, the Adaptor (4.1.2) is responsible for the relationship between the Instant Messaging SRs and the CSC's Automatic Call Distributor (ACD) (4.5). Standard ACD functionality allows a CSC to maintain a queue of SRs and matches them up with available CSRs. Typically, new SRs are added to the head of the ACD's queue and if a CSR becomes available, an SR is removed from the tail of the queue. If the IM support server is integrated with a CRM application, and the CSC decides to utilize the same queue for SRs logged both through the IM support server and through the phone, then the Adaptor (4.1.2) module can optionally add the IM support server SRs to the start of the ACD's queue, not the end. The reason for this seemingly preferential treatment is that open SRs that arrive at the CSC via the IM support server have already, in a sense, waited “on hold” so they are immediately given to the next available CSR. The Adaptor (4.1.2) interacts with the IM support server to check whether the user that created an open SR is online and, if so, invites them to initiate a chat session, in the same session window.

The Adaptor (4.1.2) interfaces with the CRM application (4.2), since it stores CRM vendor specific EAI (Enterprise Application Integration) specifications to insulate the rest of the system from a CRM application's peculiarities. The Adaptor is also the translation layer to change user data provided for the SR to the types used by the CRM application. Through API's and SDK's published by a CRM application vendor it accesses processes used for IM Knowledge and IM Service to integrate with the CRM application.

The Adaptor (4.1.2) also provides special queuing functionality to the CSC. The module allows for an active queuing method where users with open SRs are given the choice to chat with a live CSR if they are active. For instance, if user 1 logs an SR number 123 and then logs off their Instant Messenger, the IM support server will not remove the SR123 from the queue but simply rotate the SR to the end of the queue. Since hold times are calculated based on the number of users in the queue, SR123 will not be placed as an “active SR” in the queue, but rather as an “offline SR,” therefore not increasing the announced hold times for other users. However, if user 1 goes back online, the IM support server will communicate the user status to the Adaptor (4.1.2). The Adaptor (4.1.2) in turn puts the user back into active status, so that the next available CSR can attend to them. When a live CSR is ready to chat with the user and the session is transferred to the live CSR through the Broker (3.3), the Adaptor (4.1.2) will ping the user to confirm whether they are still available to chat, thereafter the session is handed of to the live CSR. Additionally, due to the quality of some Internet connections, user IM sessions keep going offline and online. To make up for this fluctuation the Adaptor module does not activate a user SR before confirming whether the user is online for a long enough period. The time parameter can vary depending upon what is set by the CSC. This will reduce the number of calls made to the SR queue.

The first version of the queue may be more suited towards preferred customers, whereas a simpler version of the queue can also be implemented. An alternative queuing method can be done by entering only “online” customers in the queue. If a new SR is submitted, it is stored under the users profile in the CRM application. The CRM application will either have its own queue or interface with an ACD queue. The IM support server, which monitors the users “online” “offline” status will communicate this to the CRM application, which will then either enter the user in the queue or remove the user from the queue based on their “online” or “offline” status. Through this method, if the SR has been logged, the user's IM presence will decide their SR being included in the queue. As mentioned in the previous queue, the system counts for the users network connection to the IM server. With this queuing method, the IM support server will send the user an “SR in queue alert,” if they respond to chat with a CSR, then they will be placed in the active queue.

The Agent (4.1.1) is a hosted admin module for the CSC contact that will administer the IM support server (3) functionality. The module is used to manage standard customer information and system preferences. Apart from this functionality, the Agent (4.1.1) will allow the CSC to manage the response messages shown to users, view and update the imported SR templates, manage resolution types that can be offered to a customer, authentication preferences and reporting tools to show IM support server usage by individual CSC's.

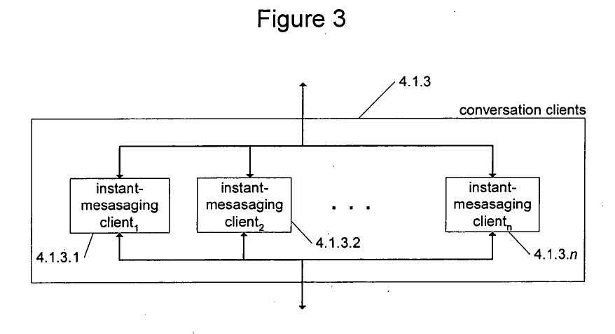

The conversation clients module (4.1.3) is a component of the IM support server (3) on the CSC instance (4). FIG. 3 shows that the conversation client's module is a collection of Instant Messaging clients. A conversation client is a customized IM tool so that the CSRs can, with a single client, chat with users on different Instant Messaging platforms. The individual chat sessions are recorded in the Adaptor (and associated with the user's profile), rather than on the IM support server (3), so that the CSC does not have to worry about sensitive data leaving their network.

For the purpose of this discussion, aside from the IM support servers components (4.1) the CSC's computer system is assumed to contain the following components: the CRM application (4.2) a database of user profiles (4.3) and a knowledge base (4.4). The user profile database maintains context between customer service profiles (e.g. what products the user owns, and the user's history of questions). The knowledge base contains questions and answers in a form that users can query. For example, the CSC could provide a mechanism by which a user can do keyword searches on the knowledge base.

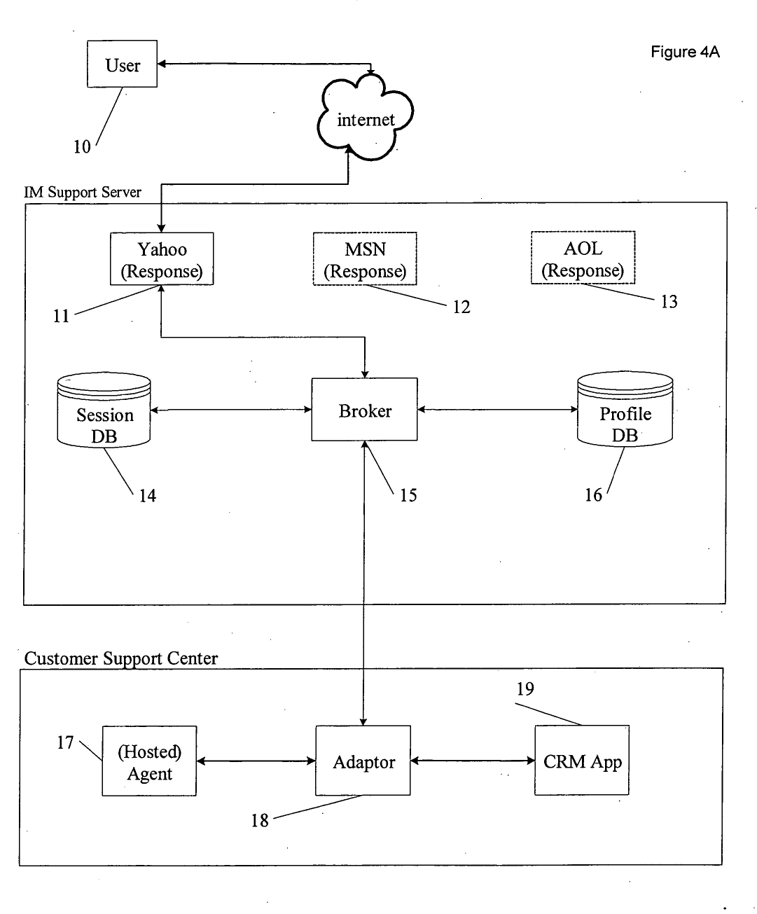

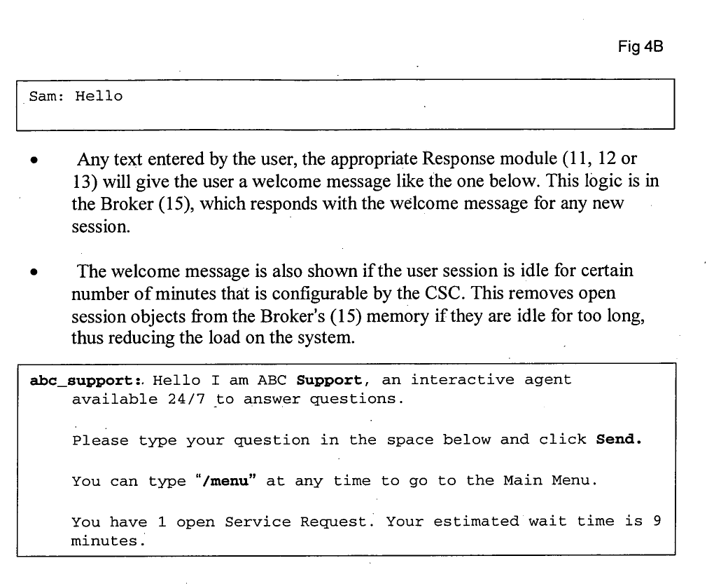

Referring next to FIG. 4A, it illustrates one embodiment of how the IM support server system reacts internally if a new user utilizes it to contact a CSC. By way of example, initially the user (10) logs in to their favorite IM client. Next, the IM client sends a message to the IM support server response module (11, 12 or 13). Let us assume that, in this case, the user (10) is using the Yahoo! Messenger IM client so the Yahoo! Response module (11) receives this message. If the user (10) had used a different IM client then another Response module (12, 13) would have been used. The Response module (11, 12, 13) responds to a user id that is specific to a CSC and a IM network. For example, ABC Corporation may desire its customers to contact ABC Technical Support at abc_support@yahoo.com, if they are using Yahoo! IM, or at abc_support@msn.com if the are using MSN Chat, etc. A user who wants to obtain support through their IM client adds the appropriate user name to their buddy list. The IM support server component also includes functionality for an IM gateway where a CSC can use a company branded ID as their IM support ID, for instance ABC Corporation would have support@abccorp.com. For the user to add an ID that is on the CSC's own domain name, the IM tool they are using allows this.

The Broker (15) launches a new Response module for every CSC and their respective IM provider. This balances the session load between different IM's on the IM support server system. A single Response module will not manage multiple protocols of Yahoo, MSN, and AOL. The Broker (15) drives the automated responses that are sent back to a user. The business logic for IM providers is common and stored in the Broker (15). If a user is using the IM support server, the Broker (15) maintains the user's current status (i.e., whether they are in IM Knowledge, IM Service or IM Chat). This information is stored as a memory object for fast retrieval of user session data. The session object is created if a user logs in to their IM and then closed based on their idle time or if they exit their session. This optimizes the system speed by having unwanted objects in memory.

The session DB (14) is used by the Broker (15) to record information about a user's session, such as online or offline status. The profile DB (16) stores information about a user that persists across multiple sessions, for example their name and account info. This information could also be stored in the CSC's CRM application (19), this choice is part of the CSC's profile. Using the profile settings of the CSC, the Broker (15) decides whether the user information is retrieved from the CSC or is stored in the profile DB. For example, banks may not want copies of user data stored outside of their systems, even though by doing so user data could be retrieved faster. Finally, the Agent (17) mediates interactions between the IM support server components that are external to the CSC and the CSC's computer system. The Adaptor (18) knows which APIs to call in order to interact with the various CRM applications (19). An example interaction is shown in FIG. 4B.

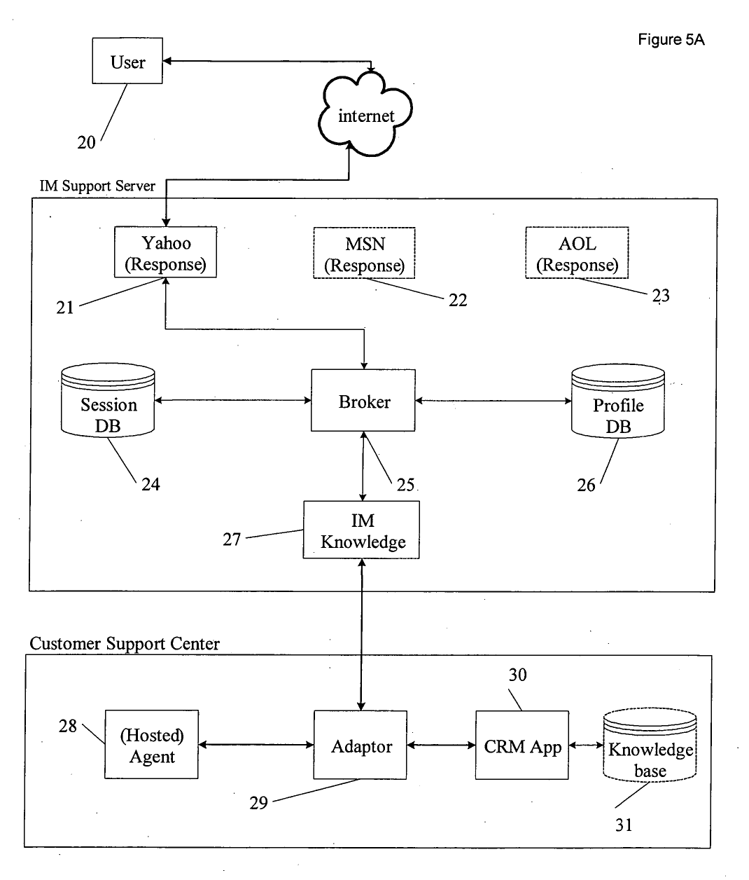

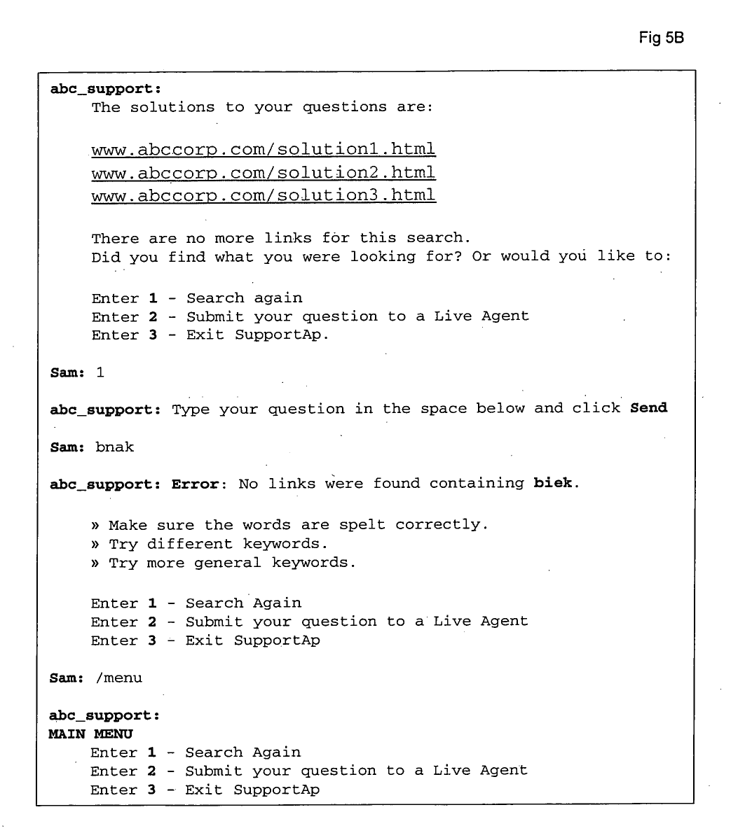

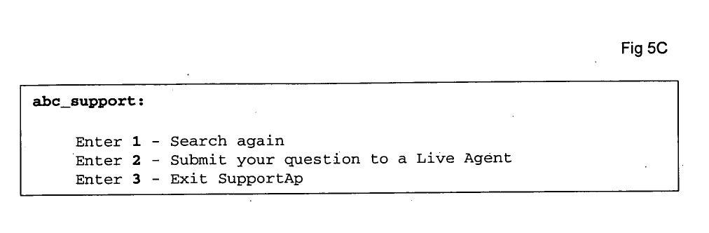

FIG. 5A illustrates the steps that are involved in that portion of a session where the user is using the IM support server to query the CSC's knowledge base. For example, if the user (20) asks a question the Response module (21, 22 or 23) will respond to the user. The user's (20) state representation in the session object (24) is updated to let the Broker (25) know that the user (20) is still in an IM Knowledge session. The search results are provided by the CSC's knowledge base (31).

The IM Knowledge module (27) sends the search query to the Adaptor (29), which turn utilizes the Web Service to route the query either directly to the CSC's knowledge base (31) or routes it through CRM application (30). The results are then returned via the reverse process to the Broker (25), Response module (21, 22 or 23), and, finally, the user (20). The IM Knowledge module (27) uses the profile database (26) to store the user's past searches. These searches can either be stored within the profile database (26) or the data can be stored in the CSC's own database under individual user accounts through functionality provided by the hosted Agent module (28). The Agent (28) allows the CSC to do analysis on the searches that were received from customers. The CSC can run customized reporting by querying the database. An example exchange is illustrated in FIG. 5B.

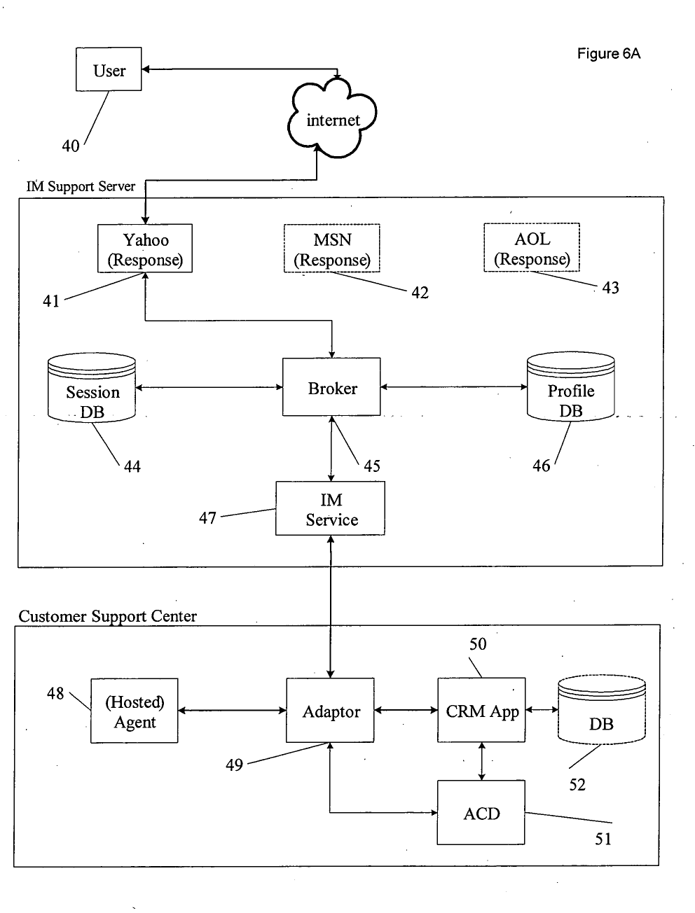

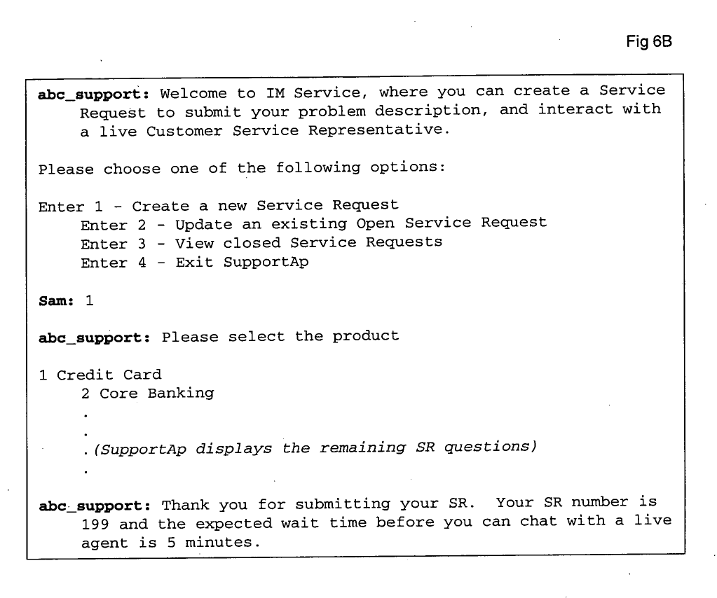

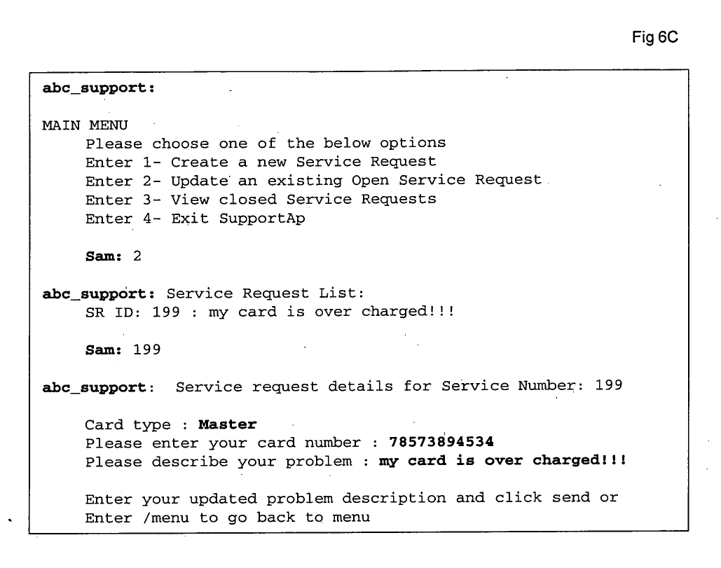

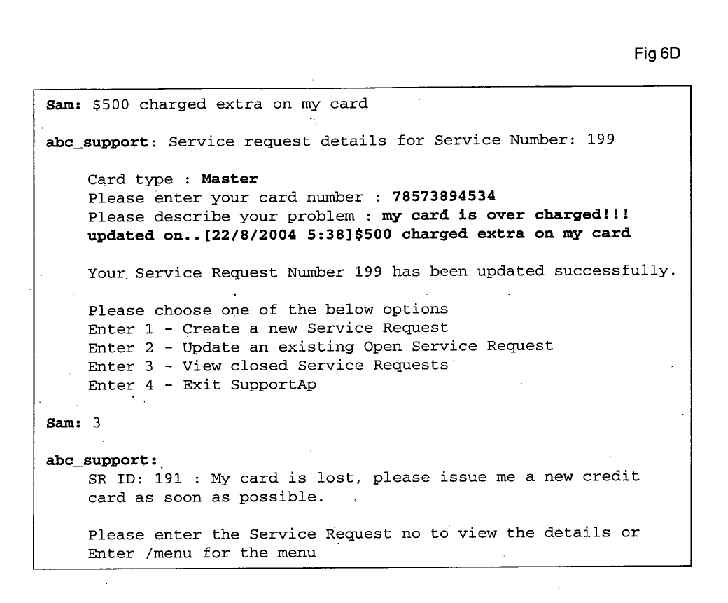

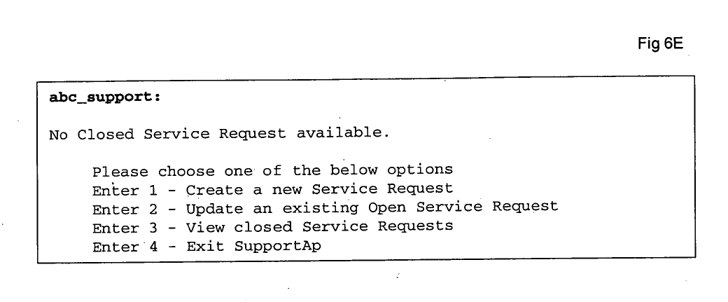

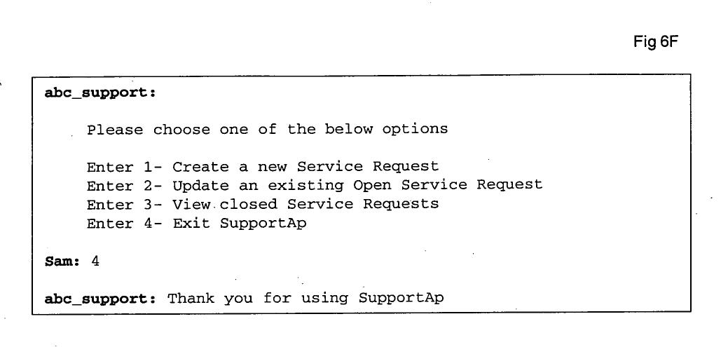

In addition to the search results, the IM Knowledge module (27) also responds with a standard menu option allowing the user to search again, submit a question to a live agent, or exit. An example interface screen is shown in FIG. 5C. The user's selection is stored in the session object in the Broker (25), which also stores the business logic behind the options. If the user selects option 2 (submit question to a live agent), the Broker (25) will transition the user session from the IM Knowledge module (27) to the IM Service module (described in FIG. 6A).

Authentication

The references made to the IM support server components to describe the user authentication can be seen in FIG. 6. For example, the transition of a user's session from IM Knowledge to IM Service can optionally be authenticated by the CSC. The Broker module (45) examines the user's session object, if it is in a state of moving between the IM Knowledge and IM Service, alerting the Broker whether the specific CSC desires user authentication.

The CSC stores their authentication preferences in the profile database (46). The preferences can include whether they wish to (a) authenticate on a secure web page—in which case the response will return a link to a web page, which the user may use to transition their session to IM Service; (b) authenticate through IM—where the user is asked for their corporate ID and password; or (c) whether authentication is desired—some CSC's may simply allow a user to log an SR without being authenticated. The session database (44) remembers the particular IM network that the user is using (such as Yahoo! Messenger or MSN Chat). If the session object in the Broker (45) is in the IM Service state, the same user cannot log in using another IM provider. For example, if a user has been authenticated in the IM Service module by using Yahoo! Messenger, then the Broker (45) will not allow the same user to login to the IM Service (47) module using MSN Messenger.

Turning to FIG. 6B, it illustrates one embodiment of the modules that are involved in the portion of a user's IM support server session in which the user is creating a new SR. The user can choose from various options to create, view, and update an SR. Additionally they can also exit the IM support server process. For example, Option 1 “Create New Request,” can be configured so that the user is asked a series of questions, which are preset by the CSC. The questions are in the form of SR templates, which are stored in the profile database (46). A CSC would load its SR template by using the Adaptor (49) to pull the CSC's existing SR templates from the CRM application (50). Along with the questions, the SR template may also include a list of acceptable answers for a question. The SR questions can also be dynamically linked together, where the answer to a previous question will decide what the next question will be. This is done through real-time synchronous messaging between the IM support server system and the CSC's CRM application. FIG. 6B illustrates one example of a user interface screen showing this process.

Additionally, the Broker (45) adds a final question to collections of SR templates, which simply allows the user to enter a problem description. The CSC can choose whether to use this field or not for building their SR's. In response to answering the questions, the user is shown a summary of the SR template before they submit it. In response to the users submitting their answers, they are committed to the profile DB. The data is stored in the IM support server before it is migrated over to the CSC's CRM application (50), using the Web Services. The data is received by the Adaptor (49), which then migrates the data into the CRM application (50). The Adaptor (49) also knows whether the data should be migrated to the ACD (51) first or to the CRM application (50) directly. The customer will then be given an SR number and the estimated wait time until their SR can be attended to by a live CSR.

Another option, Option 2, corresponds to “Update existing request.” Using the screen shots in FIG. 6C as an example, this option is now further described. Specifically, existing SRs can be pulled from the CSC's CRM application (50) or, if the CSC has allowed the SR data to be cloned into the IM support server profile database (46), the SR can more efficiently be retrieved from there. IM support server will allow the user to modify the “problem description” field of the users SR. The user can add additional comments to the problem description for the CSR's reference. In response to submitting the update, the Broker (45) sends the data to the Adaptor (49), which then updates the user's SR in the CRM application (50).

The IM support server will display the entire details of that SR as shown in FIG. 6D. The user either can enter the text to be added to the existing problem description, or alternatively, he or she can enter “/menu” to get the SR menu. If no closed SR is available then user will be given a message as shown in for example in FIG. 6E.

The next option, Option 3 refers to exiting the support application. This removes the user session from the Broker (45) and logs the user out of IM support server process. To begin the IM support server process again, the user can click on the IM buddy on their messenger, and type “hello” to start the session. FIG. 6F illustrates an example of a server user interface in this context.

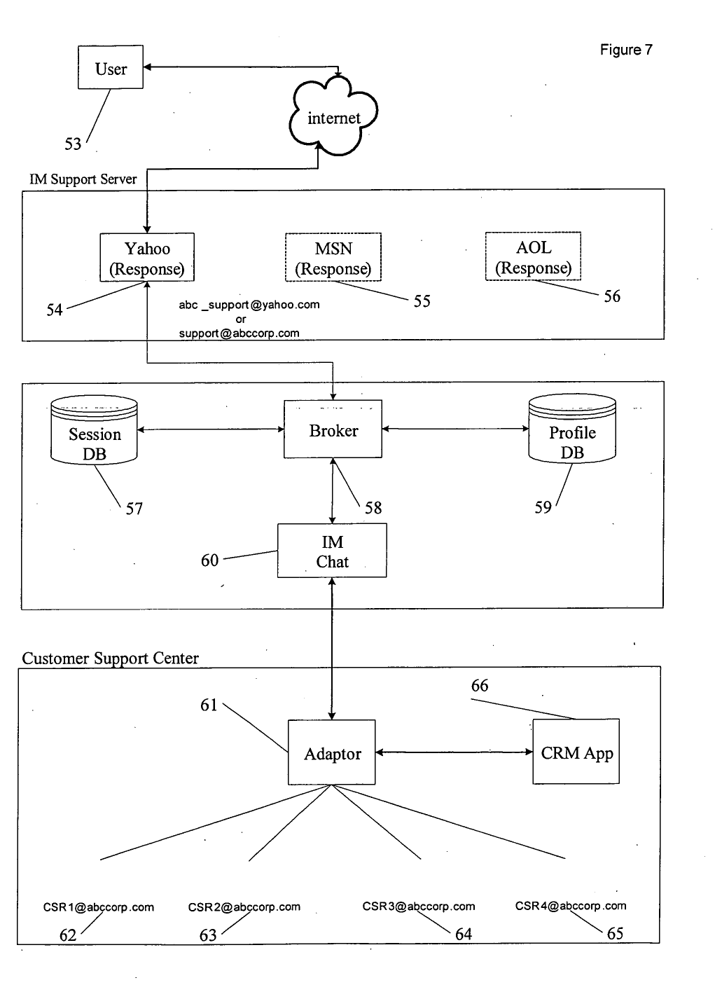

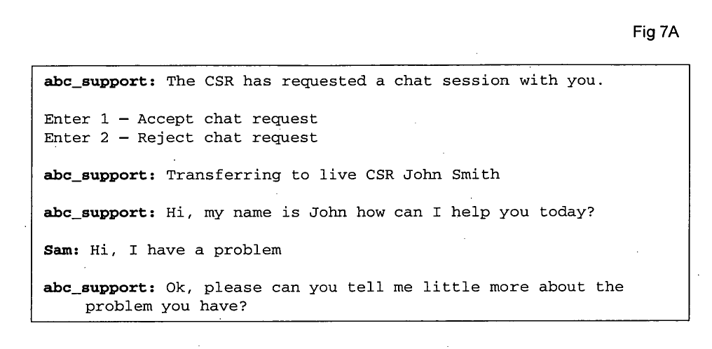

Referring now to FIG. 7 it illustrates one embodiment of modules that are involved if IM support server allows a user to chat with one or more of the CSC's CSRs. For example, in response to an SR having been submitted that has a resolution type of “chat” the user session object is moved into the IM Chat module (61). The SR has now been assigned to a CSR by the ACD or the CRM application (67). The CSC has the single IM ID that is shared by users, so that the user does not see the ID of the CSR's they are chatting with. A user who is using abc_support@yahoo.com (54) receives messages from abc₁₃ support@yahoo.com (54) even though, say, CSR2@abccorp.com (63) is chatting with the user. Messages from the user are routed through the IM Chat module (60) and a message may be stored in memory. The IM Chat module (60) waits for a response from the Adaptor (61) for a message that is received per user.

The Adaptor (61) knows which CSR a chat conversation is assigned to, and so it sends the reply message from the CSR to the same user the CSR is supporting through the IM Chat module (60). This same chat session can be transferred between agents, making it seem seamless to the user.

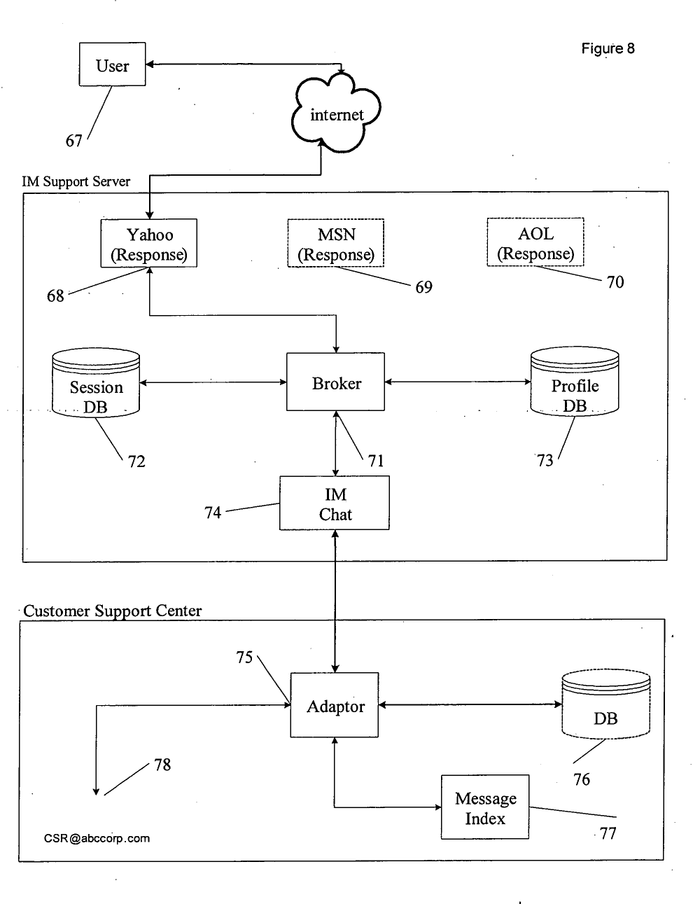

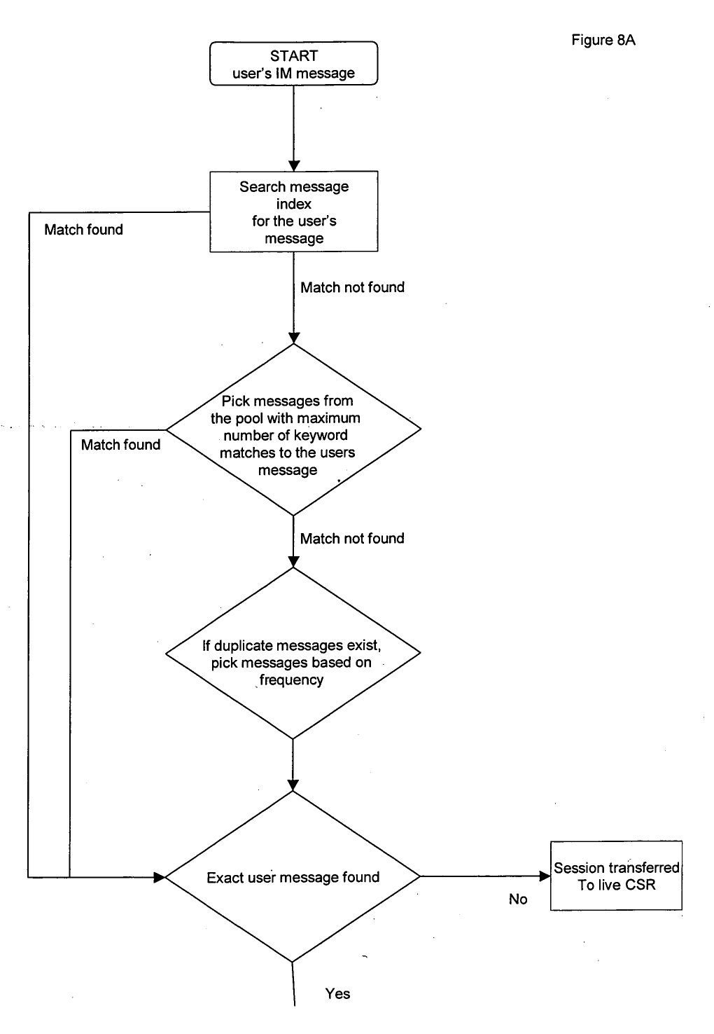

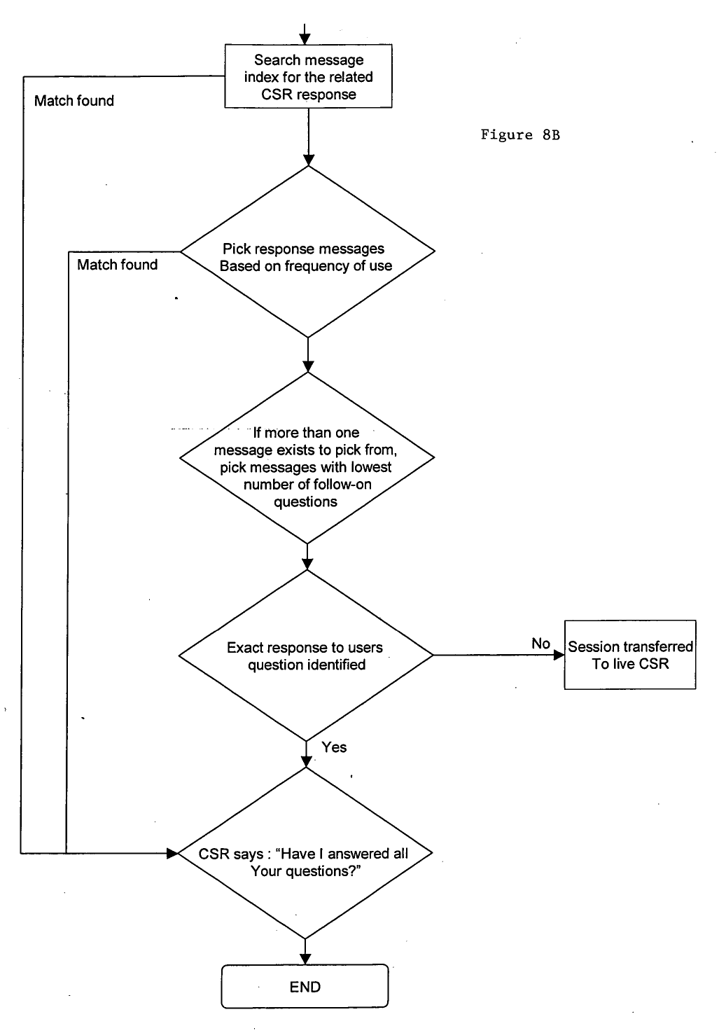

FIG. 8 shows where the Message Index component fits into the support process. Since the support process described in previous diagrams can be carried out without the implementation of the Message Index (77) being used, it has been kept as a stand-alone module. As described previously, the Adaptor (75) stores chat messages between the user and the CSR. With the implementation of the Message Index, an indexing engine is embedded which structures, the unstructured chat conversations in a format that can be stored and used for easy retrieval. If a user chooses to chat with a live CSR, the first attempt to chat is done by using existing messages that are indexed by the Message Index. For a question that is sent by the user, the Message Index finds the same question in its index. This can be done by using existing search techniques to match the maximum number of keywords in the users question with the same number in an indexed question. For easy retrieval, the user's questions can also be stored by rank.

In response to a question having been identified in an index pool, the Message Index will have a single or multiple answers linked to a question. The answers will be ranked on keyword matching and frequency of use for the particular question asked by the user, FIG. 8A. Even though, indexed answers may provide the user with the same response to their question, some answers may provide additional information, and therefore are used more frequently.

Building the index of questions and answers can be done through, for example, two methods. The first method includes using existing voice or chat data to create index pools of questions and answers. This way customers can begin using automated sessions immediately. The second method includes a learning curve method, where customer chat conversations through the IM support server are indexed over time and used to automate future conversations.

For the Message Index to work, it has to be induced with real-time chat conversations that are taking place between users and live CSR's. Therefore, the Message Index will not have an index for new issues that occur at the support center, live CSR's would have to continue addressing these queries. A user can enter a chat session with the Message Index, and the same session can be passed onto a live CSR, as more complicated issues may require human interaction.

Upon reading this disclosure, those of skill in the art will appreciate still additional alternative structural and functional designs for a system and a process for a method that uses enterprise application integration to provide real-time proactive post-sales and pre-sales service over SIP/Simple/XMPP networks through the disclosed principles of the present invention. Thus, while particular embodiments and applications of the present invention have been illustrated and described, it is to be understood that the invention is not limited to the precise construction and components disclosed herein and that various modifications, changes and variations which will be apparent to those skilled in the art may be made in the arrangement, operation and details of the method and apparatus of the present invention disclosed herein without departing from the spirit and scope of the invention as defined in the appended claims.

What is claimed is:

1. A method of providing customer support to a user, the method comprising:
providing the user access to a knowledge database for the user to query the knowledge database regarding a support issue;
providing, in response to the user querying the knowledge database, an interface to the user for the user to enter a service request; and
establishing, in response to the user entering the service request, an instant messaging session between the user and a customer support representative.

2. The method of claim 1, wherein providing the user access to the knowledge database comprises:
receiving a query from the user via an instant messaging client;
submitting the received query to the knowledge database located at a customer support center;
receiving a result of the submitted query from the knowledge database; and
providing the result to the user via the instant messaging client.

3. The method of claim 1, wherein providing the interface to the user comprises:
receiving, from a customer support center, a template specifying one or more questions, the one or more questions relating to a product or service supported by the customer support center;
providing the template to the user via an instant messaging client to collect the user's responses to the one or more questions; and
providing the service request generated based on the user's responses to the customer support center.

4. The method of claim 1, further comprising:
placing the service request in a queue to establish a priority of a plurality of service requests entered by a plurality of users.

5. The method of claim 1, wherein establishing the instant messaging session comprises:
submitting the service request to a customer support center;
receiving an indication from the customer support center that a customer support representative is available; and
establishing a communication session between an instant messaging client of the user and an instant messaging client of the available customer support representative.

6. The method of claim 1, further comprising:
maintaining the service request if the user terminates the instant messaging session and the support issue has not been resolved.

7. The method of claim 1, further comprising:
providing the interface to the user for the user to modify an existing service request or to view a terminated service request.

8. A system for providing customer support to a user, the system comprising:
a knowledge module coupled to a knowledge database for providing the user access to the knowledge database to query the knowledge database regarding a support issue;
a service module coupled to the knowledge module for providing, in response to the user querying the knowledge database, an interface to the user for the user to enter a service request; and
a messaging module coupled to the service module for establishing, in response to the user entering the service request, an instant messaging session between the user and a customer support representative.

9. The system of claim 8, wherein the knowledge module is adapted to:
receive a query from the user via an instant messaging client;
submit the received query to the knowledge database located at a customer support center;
receive a result of the submitted query from the knowledge database; and
provide the result to the user via the instant messaging client.

10. The system of claim 8, wherein the service module is adapted to:
receive, from a customer support center, a template specifying one or more questions, the one or more questions relating to a product or service supported by the customer support center;
provide the template to the user via an instant messaging client to collect the user's responses to the one or more questions; and
provide the service request generated based on the user's responses to the customer support center.

11. The system of claim 8, wherein the service module is adapted to:
place the service request in a queue to establish a priority of a plurality of service requests entered by a plurality of users.

12. The system of claim 8, wherein the messaging module is adapted to:
submit the service request to a customer support center;
receive an indication from the customer support center that a customer support representative is available; and
establish a communication session between an instant messaging client of the user and an instant messaging client of the available customer support representative.

13. The system of claim 8, wherein the service module is adapted to:
maintain the service request if the user terminates the instant messaging session and the support issue has not been resolved.

14. The system of claim 8, wherein the service module is adapted to:
provide the interface to the user for the user to modify an existing service request or to view a terminated service request.

15. A system for providing customer support to a user, the system comprising:
a means for providing the user access to the knowledge database to query the knowledge database regarding a support issue;
a means for providing, in response to the user querying the knowledge database, an interface to the user for the user to enter a service request; and
a means for establishing, in response to the user entering the service request, an instant messaging session between the user and a customer support representative.

16. The system of claim 15, wherein the means for providing the user access to the knowledge database comprises:
a means for receiving a query from the user via an instant messaging client;
a means for submitting the received query to the knowledge database located at a customer support center;
a means for receiving a result of the submitted query from the knowledge database; and
a means for providing the result to the user via the instant messaging client.

17. The system of claim 15, wherein the means for providing the interface to the user comprises:
a means for receiving, from a customer support center, a template specifying one or more questions, the one or more questions relating to a product or service supported by the customer support center;
a means for providing the template to the user via an instant messaging client to collect the user's responses to the one or more questions; and
a means for providing the service request generated based on the user's responses to the customer support center.

18. The system of claim 15, wherein the means for establishing the instant messaging session comprises:
a means for submitting the service request to a customer support center;
a means for receiving an indication from the customer support center that a customer support representative is available; and
a means for establishing a communication session between an instant messaging client of the user and an instant messaging client of the available customer support representative.

19. The system of claim 15, wherein the means for providing the interface to the user comprises:
a means for maintaining the service request if the user terminates the instant messaging session and the support issue has not been resolved.

20. The system of claim 15, wherein the means for providing the interface to the user comprises:
a means for providing the interface to the user for the user to modify an existing service request or to view a terminated service request.
